(19) United States
(12) Patent Application Publication
(10) Pub. No.: US 2008/0156349 A1
(43) Pub. Date: Jul. 3, 2008

(54) Method for cleaning silicon wafer

(75) Inventors: In-Jung Kim, Daejeon (KR); So-Ik Bae, Daejeon (KR)

Correspondence Address: GREER, BURNS & CRAIN, 300 S WACKER DR, 25TH FLOOR, CHICAGO, IL, 60606, US

(73) Assignee: SILTRON INC.

(21) Appl. No.: 11/998,919

(22) Filed: Dec. 3, 2007

(30) Foreign Application Priority Data
Dec. 29, 2006 (KR) 10-2006-0138057

(51) Int. Cl. B08B 3/08

(52) U.S. Cl. 134/3

(57) ABSTRACT

The present invention relates to a method for cleaning a silicon wafer, including (S1) a first cleaning step for cleaning surfaces of a silicon wafer using an SC-1 cleaning solution according to standard clean 1; (S2) a second cleaning step for cleaning the surfaces of the silicon wafer, cleaned in the first cleaning step, using an SC-2 cleaning solution according to standard clean 2; (S3) a third cleaning step for cleaning the surfaces of the silicon wafer, cleaned in the second cleaning step, using a hydrogen fluoride (HF) solution; and (S4) a fourth cleaning step for cleaning the surfaces of the silicon wafer, cleaned in the third cleaning step, using an ozone water. The present invention removes effectively metallic impurities on the surfaces of the silicon wafer and improves the surface roughness of the silicon wafer, and thus is capable of providing a silicon wafer with a remarkably improved physical characteristic.

### BACKGROUND OF THE INVENTION

1. Field of the Invention

The present invention relates to a method for cleaning a silicon wafer, and in particular, to a method for cleaning a silicon wafer, in which cleaning processes are performed according to standard clean 1 and 2 and subsequently followed by additional cleaning processes using a hydrogen fluoride and an ozone water.

2. Description of the Related Art

Surfaces of silicon wafers are contaminated by various impurities during a wafer fabricating process or a semiconductor process for device integration. Typically, the impurities include fine particles, organic impurities or metallic impurities. Such impurities cause the reduced production yield of semiconductor devices. Therefore, when fabricating bare silicon wafers, a cleaning process should be performed after a polishing processing using CMP (Chemical Mechanical Polishing) and after a unit semiconductor process that generates much impurities, so that the concentration of impurities is controlled to a proper level.

Meanwhile, with recent trend toward larger diameter and simpler design rule of silicon wafers, the number of cleaning processes is increased and an amount of chemical materials used in the cleaning processes is also increased steadily. As a result, production costs of semiconductor devices are increased, and considerable costs are spent in treating a large quantity of chemical materials emitted in the cleaning processes.

A typical RCA-type cleaning method belongs to a wet cleaning method and is one of methods for cleaning a silicon wafer widely used so far. Other type cleaning methods are suggested to supplement weaknesses of the typical RCA-type cleaning method.

The typical RCA-type cleaning method is a high-temperature wet process using chemicals of high concentration of strong acid and strong base. The typical RCA-type cleaning method consists of two steps: standard clean 1 (called ‘SC-1’ for short) and standard clean 2 (called ‘SC-2’ for short).

The standard clean 1 (SC-1) is proceeded at temperature of about 75 to about 90° C. using a mixed cleaning solution (hereinafter referred to as an ‘SC-1 cleaning solution’) of ammonia water, hydrogen peroxide and DI (deionized) water. The SC-1 is performed by simultaneously repeating the oxidation of wafer surface by the hydrogen peroxide and the fine etching of wafer surface by the ammonia water to remove organic impurities and metallic impurities (Au, Ag, Cu, Ni, Cd, Zn, Co or Cr) from the wafer surface.

The standard clean 2 (SC-2) is proceeded at temperature of about 75 to about 85° C. using a mixed cleaning solution (hereinafter referred to as an ‘SC-2 cleaning solution’) of hydrochloric acid, hydrogen peroxide and DI water. The SC-2 removes alkali ions (Al³⁺, Fe³⁺, Mg²⁺), hydroxides such as Al(OH)₃, Mg(OH)₂ or Zn(OH)₂, and remaining impurities not removed in the SC-1.

However, the typical SC-1 cleaning solution causes metal induced pits (called ‘MIPs’ for short) occurring when etching the surfaces of a silicon substrate or removing the metallic impurities from the surfaces of the silicon substrate, so that the surfaces of the silicon substrate may become rough. As a result, the typical SC-1 cleaning solution infavorably reduces an electrical characteristic of an insulating layer formed on the silicon substrate.

To solve the problem, Japan Laid-open Patent Publication No. 8-124889 suggests a technique that cleans a semiconductor wafer using a hydrogen fluoride aqueous solution, subsequently cleans the semiconductor wafer using a pure water containing ozone, and then performs a brush cleaning on the semiconductor wafer. The technique advantageously makes the surfaces of the silicon wafer clean, however, in the case that plenty of impurities such as metallic ions exist on the surfaces of the silicon wafer, a single-time cleaning process according to the technique may be insufficient to completely remove the impurities and the removed metallic impurities may be attached to the silicon wafer again. Thus, disadvantageously the technique should repeat the cleaning process for improved cleaning effect.

As described above, if the typical RCA-type cleaning method performed on the silicon surface and the technique suggested to supplement the weaknesses of the typical RCA-type cleaning method are used in combination, impurities present on the surfaces of the silicon wafer may be removed or the surface roughness of the silicon wafer may be improved. In this case, however, an excessive amount of cleaning solution is used, so that a dehydrogenation process should be performed when treating waste water after the cleaning processes and process costs are increased. Further, the cleaning processes should be performed at high temperature, so that much energy is consumed, and a portion of the metallic impurities removed by the cleaning processes is attached to the silicon wafer again and acts as contamination.

Studies have been continuously made in the related art to simultaneously solve the problems of the conventional methods for cleaning a silicon wafer, and under such a technical environment, the present invention was filed for a patent.

It is an object of the present invention to effectively remove the metallic impurities present on the surfaces of the silicon wafer and improve the surface roughness of the silicon wafer. Further, it is an object of the present invention to prevent adverse effects caused by repetition of processes and use of an excessive amount of cleaning solution and recontamination caused by reattachment of the removed metallic impurities. Therefore, it is an object of the present invention to provide a method of cleaning a silicon wafer, capable of achieving these technical objects.

### SUMMARY OF THE INVENTION

In order to achieve the above-mentioned objects, the method for cleaning a silicon wafer includes (S1) a first cleaning step for cleaning the surfaces of a silicon wafer using an SC-1 cleaning solution according to standard clean 1; (S2) a second cleaning step for cleaning the surfaces of the silicon wafer, cleaned in the first cleaning step, using an SC-2 cleaning solution according to standard clean 2; (S3) a third cleaning step for cleaning the surfaces of the silicon wafer, cleaned in the second cleaning step, using a hydrogen fluoride (HF) solution; and (S4) a fourth cleaning step for cleaning the surfaces of the silicon wafer, cleaned in the third cleaning step, using an ozone water.

### BRIEF DESCRIPTION OF THE DRAWINGS

Hereinafter, preferred embodiments of the present invention will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present invention on the basis of the principle that the inventor is allowed to define terms appropriately for the best explanation.

FIG. 1 is a flow chart illustrating a method for cleaning a silicon wafer according to the present invention.

FIG. 2 is a graph illustrating a metallic impurity removing effect taken by the method for cleaning a silicon wafer according to the present invention.

FIG. 3 is a graph illustrating a surface roughness improving effect taken by the method for cleaning a silicon wafer according to the present invention.

### DESCRIPTION OF THE PREFERRED EMBODIMENT

Hereinafter, preferred embodiments of the present invention will be described in detail with reference to the accompanying drawings.

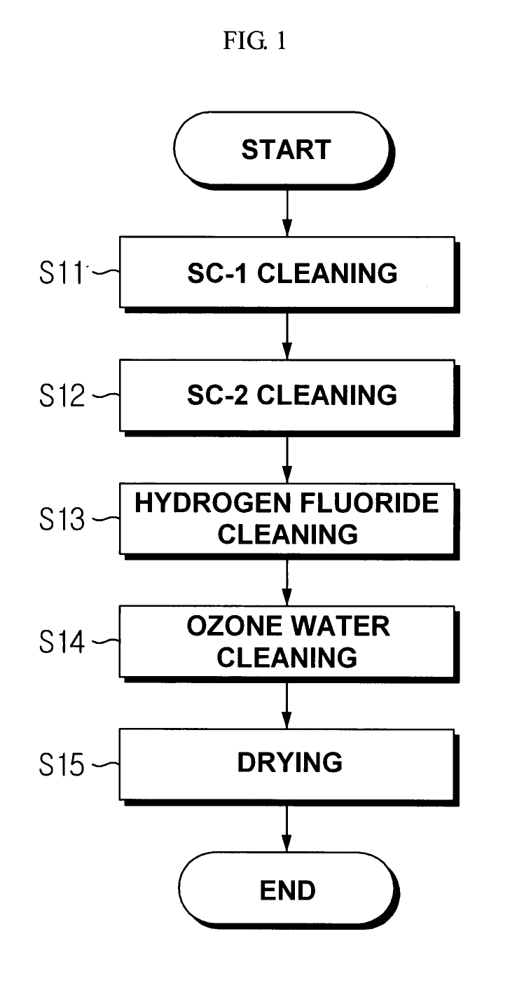

FIG. 1 is a flow chart illustrating a method for cleaning a silicon wafer according to the present invention.

Referring to FIG. 1, an entire cleaning process consists of four steps: (S11) a first step for cleaning using an SC-1 cleaning solution; (S12) a second step for cleaning using an SC-2 cleaning solution; (S13) a third step for cleaning using a hydrogen fluoride (HF) solution; (S14) a fourth step for cleaning using an ozone water; and (S15) a fifth step for drying the cleaned silicon wafer.

During a sequential progress of the steps (S11) to (S14), each step commonly includes removing the cleaning solution, used in the previous step and remaining on the surfaces of the silicon wafer, using DI (deionized) water.

The step (S11) is performed using the SC-1 cleaning solution that is a mixed solution of ammonia water and hydrogen peroxide, and the step (S12) is performed using the SC-2 cleaning solution that is a mixed solution of hydrochloric acid and hydrogen peroxide. However, a portion of metallic impurities such as copper, gold, cobalt, zinc or calcium may still remain on the surfaces of the silicon wafer, and in the case that the remaining metallic impurities are left alone, the metallic impurities may disperse into the surfaces of the silicon wafer. For complete removal of the metallic impurities, a subsequent process is required to solve an additional contamination problem caused by reattachment of the removed metallic impurities to the surfaces of the silicon wafer.

Specifically, although the cleaning steps (S11) and (S12) are performed, it is required to remove the metallic impurities remaining on the surfaces of the silicon wafer effectively and completely and prevent the removed metallic impurities from reattaching to the silicon wafer, thereby maximizing a cleaning effect. For this purpose, additional cleaning steps, (S13) and (S14) need to be performed sequentially after the steps (S11) and (S12).

In the step (S13) for cleaning using the hydrogen fluoride solution, the hydrogen fluoride solution is capable of effectively removing the metallic impurities remaining on a silicon dioxide film of the surfaces of the silicon wafer. Preferably, the hydrogen fluoride solution used in the step (S13) is a diluted hydrogen fluoride solution. Preferably, the diluted hydrogen fluoride solution has a concentration of 0.5 to 1%. In the case that the concentration of the diluted hydrogen fluoride solution is less than the minimum, it is not preferable because an effective etching effect of the silicon dioxide film is not obtained, and in the case that the concentration of the diluted hydrogen fluoride solution is more than the maximum, it is not preferable because an etching effect of the silicon dioxide film is not too large, compared with increase of concentration of the hydrogen fluoride. In this example of the present invention, the hydrogen fluoride of a concentration of 1% was used.

In the step (S14) for cleaning using the ozone water, a strong oxidation power of ozone promotes the removal of metallic impurities and prevents the removed metallic impurities from reattaching to the silicon wafer. In other words, the ozone water used in the step (S14) exhibits a higher oxidation reduction potential than hydrogen peroxide, and thus has a strong oxidation power to strongly ionize the impurities, in particular metallic impurities, thereby preventing the metallic impurities from attaching to the surfaces of the silicon wafer. Preferably, the step (S14) is performed such that the silicon wafer cleaned in the step (S13) is soaked into the ozone water for 1 to 10 minutes. In the case that the soaking time is less than the minimum, it is not preferable because a sufficient cleaning effect is not obtained, and in the case that the soaking time is more than the maximum, it is not preferable in terms of throughput because the silicon wafer almost cleaned to a desired extent is excessively soaked. Preferably, the ozone water used as the cleaning solution in the step (S14) has an ozone concentration of 1 to 20 ppm and temperature of 10 to 30° C. In the case that the ozone concentration is less than the minimum, it is not preferable because organic impurities are not removed effectively, and in the case that the ozone concentration is more than the maximum, it is not preferable because a cleaning effect is not too large, compared with increase of the ozone concentration. Meanwhile, in the case that the temperature of the ozone water is less than the minimum, it is not preferable because activity of the ozone is reduced, thereby reducing a cleaning effect, and in the case that the temperature of the ozone water is more than the maximum, it is not preferable because the ozone concentration is reduced, thereby reducing a cleaning effect.

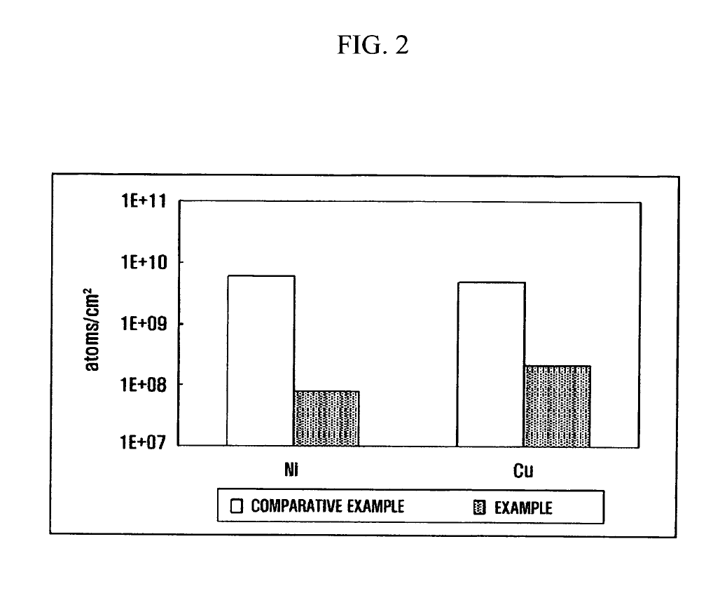

FIG. 2 is a graph illustrating a metallic impurity removing effect taken by the method for cleaning a silicon wafer according to the present invention.

Referring to FIG. 2, the graph illustrates contamination concentrations of the metallic impurities on the silicon wafer after each cleaning process in a conventional case (comparative example) incorporated by cleaning processes using only the SC-1 and SC-2 cleaning solutions and a case (example) using the four cleaning steps according to the present invention. In other words, FIG. 2 compares a difference in contamination concentration on the silicon wafer between typical metallic impurities, i.e. nickel (Ni) and copper (Cu) in the comparative example and the example, and shows that nickel of the example has lower contamination concentration of about 100(×10²) times as much as that of the comparative example, and that copper of the example has lower contamination concentration of about 10(×10¹) times as much as that of the comparative example.

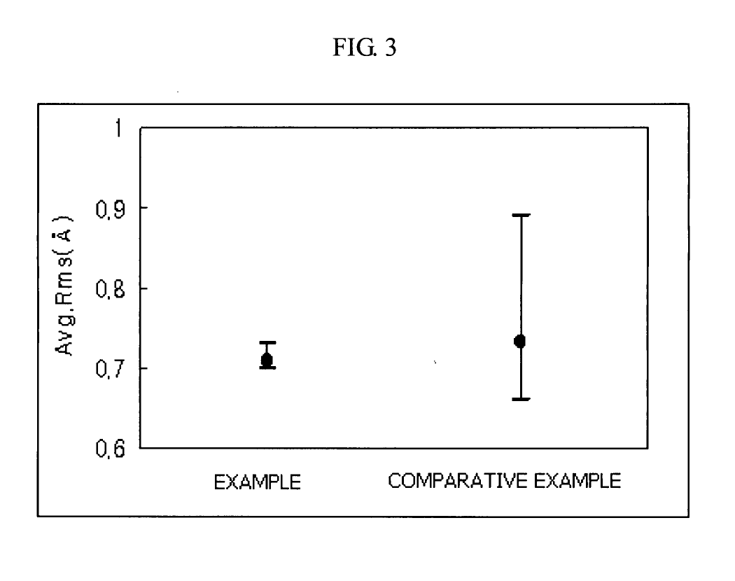

FIG. 3 is a graph illustrating a surface roughness improving effect taken by the method for cleaning a silicon wafer according to the present invention.

Referring to FIG. 3, the graph illustrates the variation of Rms (Root mean square) roughness, through which the surface roughness of the silicon wafer is judged, in the conventional case (comparative example) incorporated by cleaning processes using only the SC-1 and SC-2 cleaning solutions and the case (example) using the four cleaning steps according to the present invention. In other words, FIG. 3 shows measurement results about the surface roughness on the surfaces of the silicon wafer in the example and the comparative example. It is found that the example has a variation of 0.04 Å and a uniform surface with Rms value of 0.7 Å, and the comparative example has a variation of 0.25 Å and an ununiform surface with Rms value of 0.65 to 0.9 Å. This means that the example has the improved surface roughness of 700% or more as compared with the comparative example, and therefore, it is obvious that the present invention has a remarkably improved effect than the prior art.

It should be understood that the detailed description and specific examples, while indicating preferred embodiments of the invention, are given by way of illustration only, since various changes and modifications within the spirit and scope of the invention will become apparent to those skilled in the art from this detailed description.

### APPLICABILITY TO THE INDUSTRY

The present invention removes effectively the metallic impurities on the surfaces of the silicon wafer and improves the surface roughness of the silicon wafer, and the present invention further solves the problems of the conventional cleaning method, i.e. adverse effects caused by repetition of processes and use of an excessive amount of cleaning solution and recontamination caused by reattachment of the removed metallic impurities. Therefore, in manufacturing an electrical device, the present invention has an advantage of providing a silicon wafer having a remarkably improved physical characteristic.

What is claimed is:

1. A method for cleaning a silicon wafer, comprising:
(S1) a first cleaning step for cleaning surfaces of a silicon wafer using an SC-1 cleaning solution according to standard clean 1;
(S2) a second cleaning step for cleaning the surfaces of the silicon wafer, cleaned in the first cleaning step, using an SC-2 cleaning solution according to standard clean 2;
(S3) a third cleaning step for cleaning the surfaces of the silicon wafer, cleaned in the second cleaning step, using a hydrogen fluoride (HF) solution; and
(S4) a fourth cleaning step for cleaning the surfaces of the silicon wafer, cleaned in the third cleaning step, using an ozone water.

2. The method for cleaning a silicon wafer according to claim 1,
wherein the hydrogen fluoride solution used in the step (S3) is a diluted hydrogen fluoride solution.

3. The method for cleaning a silicon wafer according to claim 2,
wherein the diluted hydrogen fluoride solution has a concentration of 0.5 to 1%.

4. The method for cleaning a silicon wafer according to claim 1, wherein the step (S4) is performed by soaking the silicon wafer cleaned in the third cleaning step into the ozone water for 1 to 10 minutes.

5. The method for cleaning a silicon wafer according to claim 4,
wherein the ozone water is used with concentration of 1 to 20 ppm and temperature of 10 to 30° C.
